(19) United States
(12) Patent Application Publication
(10) Pub. No.: US 2017/0142247 A1
(43) Pub. Date: May 18, 2017

(54) AUTONOMOUS BABY CARRIAGE AND METHOD OF CONTROLLING THE SAME

(71) Applicant: Hyundai Motor Company, Seoul (KR)

(72) Inventors: Dong-Pil Heo, Seoul (KR); Kyu-Hyung Lim, Yongin (KR); Chi-Young An, Cheongju (KR); Dong-Hyun Lee, Seoul (KR); Young-Ki Jeong, Seoul (KR); Tai-Ho Yang, Hwaseong (KR); Ryuk Kim, Seoul (KP)

(21) Appl. No.: 15/244,463

(22) Filed: Aug. 23, 2016

(30) Foreign Application Priority Data
Nov. 18, 2015 (KR) 10-2015-0161857

(51) Int. Cl. H04M 1/725; H04W 4/00

(52) U.S. Cl. CPC H04M 1/72533; H04W 4/005; H04W 4/008

(57) ABSTRACT

An autonomous baby carriage is provided and includes a sensor module that detects a baby's condition to generate baby's condition information or detects a surrounding environment to generate surrounding environment information. A controller then determines the baby's condition information or the surrounding environment information to generate driving pattern information and a drive module is driven according to the driving pattern information.

### CROSS-REFERENCE(S) TO RELATED APPLICATIONS

This application claims priority to Korean Patent Application No. 10-2015-0161857 filed on Nov. 18, 2015, which is incorporated herein by reference in its entirety.

### BACKGROUND

Field of the Invention

The present invention relates to a baby carriage; and, more particularly, to an autonomous baby carriage driven by detecting a baby's condition using an autonomous module and a sensor coupled to each other, and a method of controlling the same.

Description of Related Art

In general, a baby carriage provides a movement function, a play function, and/or a sleep assistance function. This baby carriage may be classified into a manual baby carriage which is directly pushed and moved by a person and an electric baby carriage which is moved by an electric device such as a motor. In addition, a wheel holding mechanism for rotatably holding wheels is installed at the lower end of a baby carriage leg. The baby carriage wheel holding mechanism typically restricts the unintended traveling or moving of the baby carriage, and has a brake device for restricting the rotation of wheels.

Since the manual baby carriage is moved by a pushing motion of the baby carriage, it is considerably inconvenient for use. Particularly, it may be difficult for parents to feed babies and put babies to sleep during movement of the baby carriage, or to conduct other activities. Meanwhile, since the electric baby carriage is moved regardless of baby's conditions, parents may not be able to check on the baby's conditions.

### SUMMARY

An exemplary embodiment of the present invention is directed to an autonomous baby carriage which determines a baby's condition to be driven based on the determined baby's condition, and a method of controlling the same. Another exemplary embodiment of the present invention is directed to an autonomous baby carriage capable of providing parents with information about a baby in various forms, and a method of controlling the same.

Other objects and advantages of the present invention can be understood by the following description, and become apparent with reference to the exemplary embodiments of the present invention. Additionally, it is obvious to those skilled in the art to which the present invention pertains that the objects and advantages of the present invention may be realized by the means as claimed and combinations thereof.

In order to accomplish the above objects, an autonomous baby carriage is provided that determines a baby's condition to be driven based on the determined baby's condition. In accordance with an exemplary embodiment of the present invention, an autonomous baby carriage may include a sensor module configured to detect a baby's condition to generate condition information or configured to detect surroundings (e.g. surrounding environment) to generate surrounding information, a controller configured to determine the baby's condition information or the surrounding information to generate driving pattern information, and a drive module driven based on the driving pattern information.

The baby's condition information may be at least one of a baby's cry, a baby's temperature, and a baby's smell. The sensor module may include at least one of a voice recognition sensor configured to recognize the baby's cry, a temperature sensor configured to measure the baby's temperature, and a smell recognition sensor configured to detect defecation. The autonomous baby carriage may further include an interlocking control module interlocked with a mobile communication terminal to transmit alarm information or the baby's condition information generated by the controller to the mobile communication terminal.

The mobile communication terminal may be configured to communicate with the interlocking control module via Bluetooth. The sensor module may include an Internet of Things (IOT) configured to detect the surrounding environment information. The driving pattern information may be selected from a database in which previous baby's condition information is repeatedly learned and stored. The baby's condition information may be distinguished using a basic frequency and an intensity of the baby's cry.

In accordance with another exemplary embodiment of the present invention, a method of controlling an autonomous baby carriage may include detecting a baby's condition to generate baby's condition information or detecting surrounding environment to generate surrounding information using a sensor module, determining the baby's condition information or the surrounding environment information to generate driving pattern information using a controller, and driving a drive module based on the driving pattern information. The method may further include transmitting alarm information or the baby's condition information generated by the controller to a mobile communication terminal using an interlocking control module interlocked with the mobile communication terminal.

### BRIEF DESCRIPTION OF THE DRAWINGS

The accompanying drawings, which are included to provide a further understanding of the invention and are incorporated in and constitute a part of this application, illustrate exemplary embodiment(s) of the invention and together with the description serve to explain the principle of the invention. In the drawings:

FIG. 1 is a conceptual view illustrating a relationship between a mobile communication terminal and a baby carriage according to an exemplary embodiment of the present invention;

FIG. 2 is a block diagram illustrating components of the baby carriage illustrated in FIG. 1 according to an exemplary embodiment of the present invention;

FIG. 3 is a block diagram illustrating components of a controller illustrated in FIG. 2 according to an exemplary embodiment of the present invention; and

FIGS. 4A, B and C are flowcharts illustrating a process of detecting a baby's condition and providing the mobile communication terminal with information about the detected baby's condition according to the exemplary embodiment of the present invention.

### DETAILED DESCRIPTION

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Exemplary embodiments of the present invention will be described below in more detail with reference to the accompanying drawings. The present invention may, however, be embodied in different forms and should not be construed as limited to the exemplary embodiments set forth herein. Rather, these exemplary embodiments are provided so that this disclosure will be thorough and complete, and will fully convey the scope of the present invention to those skilled in the art. Therefore, it should be understood that the scope and spirit of the present invention can be extended to all variations, equivalents, and replacements in addition to the appended drawings of the present invention.

Throughout the disclosure, like reference numerals refer to like parts throughout the various figures and exemplary embodiments of the present invention. Furthermore, the terms including expressions, such as first and/or second, used in the specification of the present invention may be used to describe various elements of the present invention. However, the elements of the present invention should not be limited by the terms used in the specification of the present invention. In other words, such terms will be used only to differentiate one element from other elements of the present invention.

For example, without deviating from the scope and spirit of the present invention, a first element may be referred to as a second element, and, similarly, a second element may also be referred to as a first element. As used herein, the term “and/or” includes any and all combinations of one or more of the associated listed items. Unless otherwise defined, all terms, including technical and scientific terms, used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, an autonomous baby carriage using a minimum reference point and a method of controlling the same according to an exemplary embodiment of the present invention will be described below in more detail with reference to the accompanying drawings.

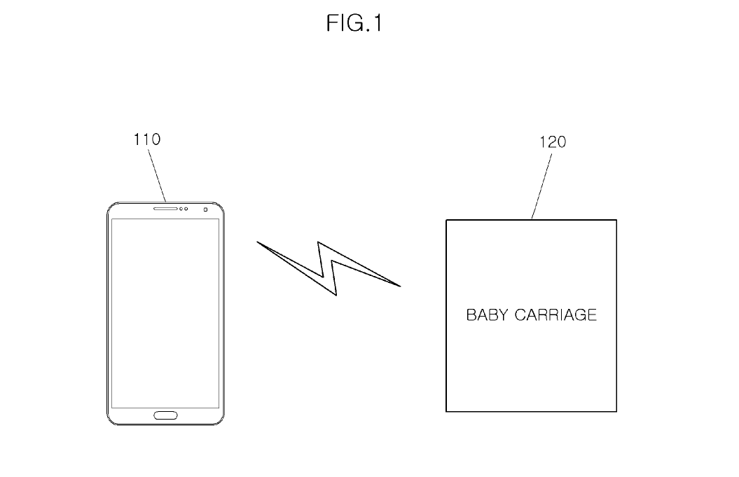

FIG. 1 is a conceptual view illustrating a relationship between a mobile communication terminal and a baby carriage according to an exemplary embodiment of the present invention. FIG. 1 illustrates a mobile communication terminal 110 configured to communicate with a baby carriage 120. Particularly the mobile communication terminal 110 may include a smart phone, a notepad, a notebook, a mini pad, etc. In addition, although Bluetooth may be mainly used for communication between the mobile communication terminal 110 and the baby carriage 120, wireless fidelity (WIFI), Internet of Things (IOT), infrared-ray communication, etc. may be used therefor.

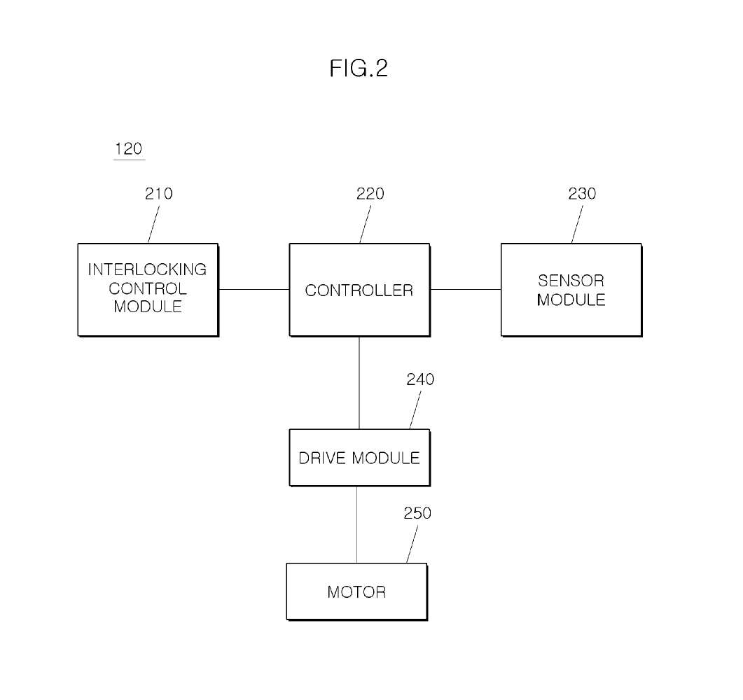

FIG. 2 is a block diagram illustrating components of the baby carriage illustrated in FIG. 1. Referring to FIG. 2, the autonomous baby carriage 120 may include an interlocking control module 210 interlocked with the mobile communication terminal 110, a controller 220 configured to operate the autonomous baby carriage 120, a sensor module 230 (e.g., a sensor 230) configured to detect a baby's condition in the baby carriage and/or surrounding environment information, a drive module 240 driven according to control of the controller 200, a motor 250 driven by the drive module 240, etc.

Although the autonomous baby carriage 120 may include wheels, a gear, a battery, a memory, etc. in addition to the above components, the remaining components will be omitted for clear understanding of the present invention. The interlocking control module 210 may be interlocked with the mobile communication terminal 110 and may be configured to transmit alarm information and/or baby's condition information generated by the controller 220 to the mobile communication terminal.

The sensor module 230 may be configured to detect a baby's condition in the baby carriage to generate baby's condition information. In addition, the sensor module 230 may be configured to detect surrounding environment of the baby carriage to generate surrounding information. Accordingly, the sensor module 230 may include a voice recognition sensor configured to recognize a baby's cry, a temperature sensor configured to measure a baby's temperature, a smell recognition sensor configured to detect defecation or other odor, a position measurement sensor configured to measure a position of the baby within the carriage, a sensor for measuring a distance, etc. Of course, the sensor module 230 may use an Internet of Things (IOT) for checking surrounding information.

The controller 220 may be configured to determine the baby's condition information and/or the surrounding information to generate driving pattern information to determine the traveling speed and direction of the autonomous baby carriage 120. In particular, the baby's condition information may include a baby's cry, a baby's temperature, a baby's smell, etc. The surrounding information may include locations of pediatric hospitals, restrooms, restaurants, etc. in the vicinity of the carriage (e.g., stroller). In addition, the controller 220 may be configured to create a database in which previous baby's condition information may be repeatedly learned and stored. The database may be created in a memory of the controller 220, or may be created using a separate storage unit. Accordingly, the controller 220 may be configured to select driving pattern information from the database, in which previous baby's condition information is repeatedly learned and stored, to execute the driving pattern information.

The drive module 240 may be configured to drive or operate the motor 250 based on the driving pattern information generated by the controller 220. Although the drive module 240 and the motor 250 are depicted as being separated from each other in the drawings for convenience of understanding, they may be integrated. In addition, the motor 250 may include a drive motor configured to drive the baby carriage, a control motor configured to operate the baby carriage, etc. The term such as “part”, “device”, or “module” described herein means a unit for processing at least one function or operation, and this may be executed by hardware and software.

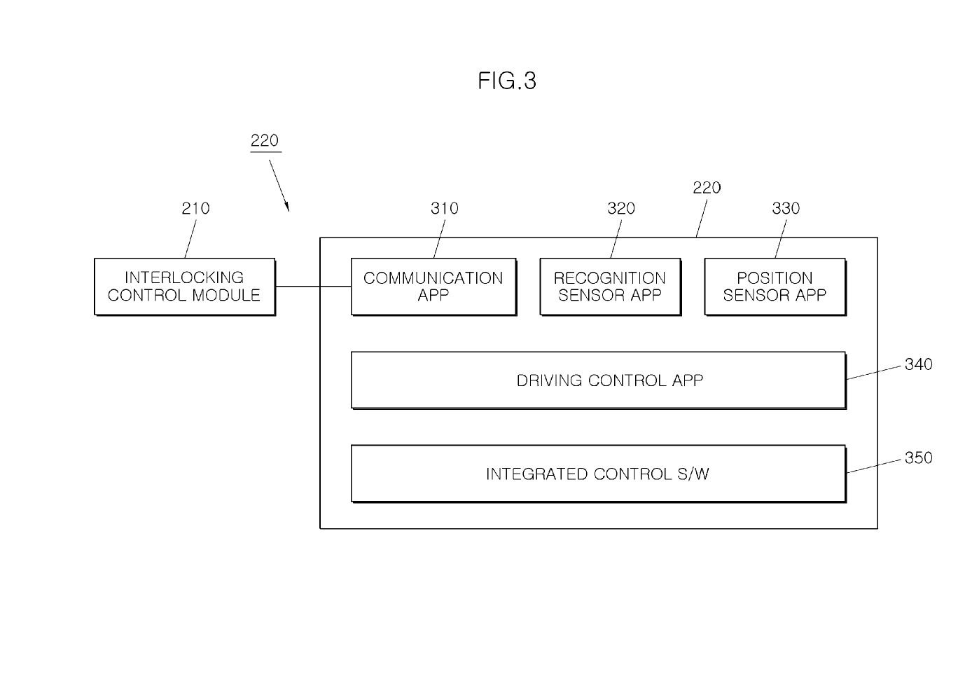

FIG. 3 is a block diagram illustrating components of the controller illustrated in FIG. 2. Referring to FIG. 3, the controller 220 may be installed with a communication application (app) 310, a recognition sensor application 320, a position sensor application 330, a driving control application 340, etc. In addition, the controller 200 may be installed with integrated control software 350 to operate the controller 220. Although the communication app 310, the recognition sensor app 320, the position sensor app 330, and the driving control app 340 may be installed by communication, they may be programmed and realized in the controller 220. Alternatively, they may be configured of separate hardware (e.g., separate sensors).

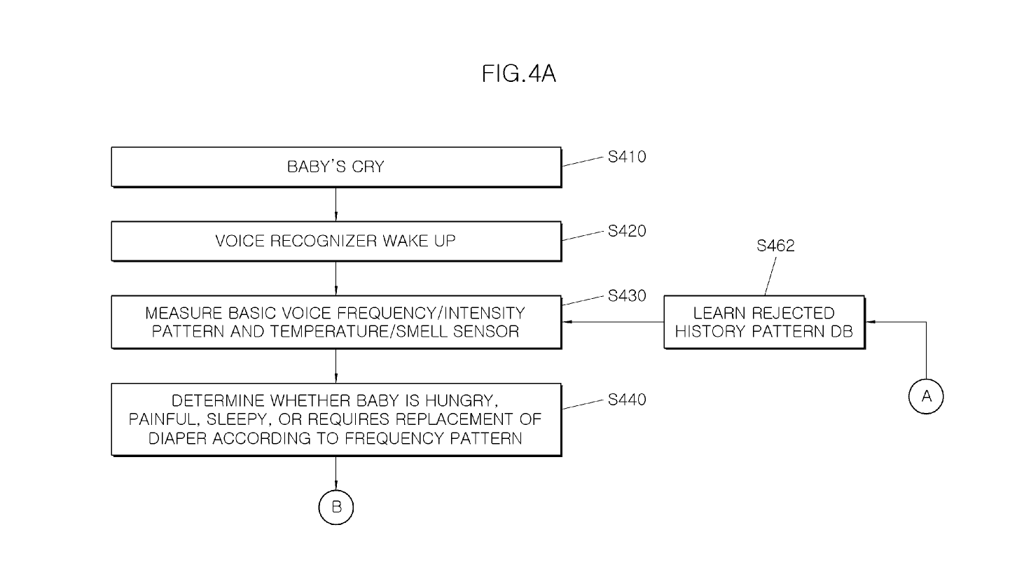

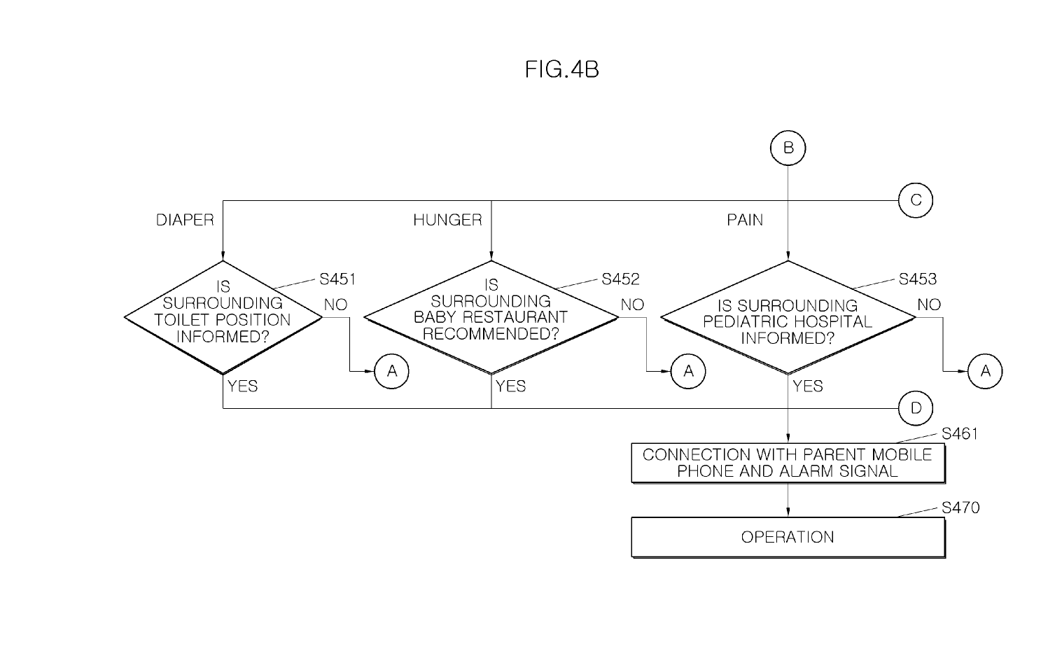

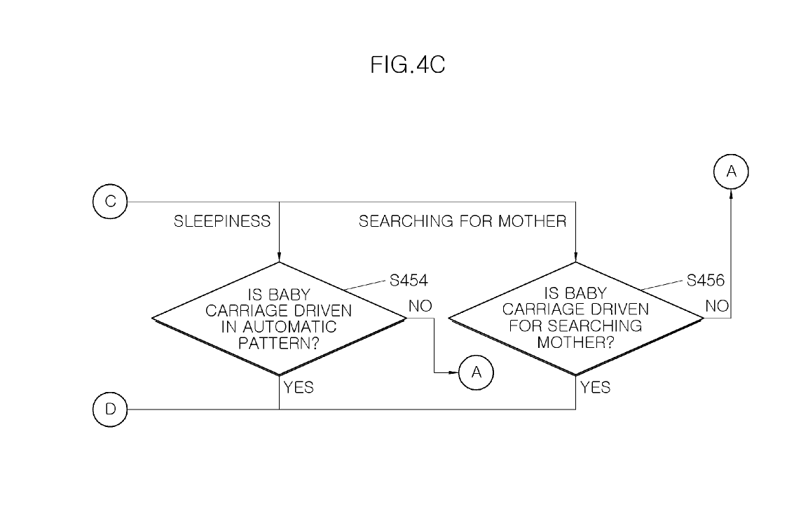

FIGS. 4A, 4B, and 4C are flowcharts illustrating a process of detecting a baby's condition and providing the mobile communication terminal with information regarding the detected baby's condition according to the exemplary embodiment of the present invention. The autonomous baby carriage 120 is depicted as being operated using a baby's cry in the baby carriage 120 in FIGS. 4A, 4B, and 4C, but the present invention is not limited thereto. For example, the autonomous baby carriage 120 may be operated using surrounding environment information.

Referring to FIG. 4A, the sensor module 230 (see FIG. 2) may be configured to detect a baby's condition (i.e., a baby's cry) to measure the voice frequency, the intensity, the pattern, etc. of the baby's cry (steps S410 to S430). Additionally, the sensor module 230 may be configured to measure a baby's temperature, a baby's smell, etc.

Additionally, using the various measured values, various conditions of the baby may be determined such as whether a baby is hungry, in pain, sleepy, or requires replacement of a diaper (step S440). For example, there is a difference between a cry when a baby is hungry and a cry when a baby is in pain. Accordingly, when average values for a basic frequency and an intensity of baby′ cry and a noise to harmonics ratio are meaningful, and average values for variation in amplitude and variation in frequency are not meaningful, it may be possible to distinguish the baby's cries by comparing the basic frequency and the intensity.

Referring to FIGS. 4B and 4C, whether the baby requires replacement of the diaper, is hungry, in pain, or sleepy may be determined using the above method, and thus, information may be provided or the baby carriage 120 may be driven according to the determined result (steps S451 to S456). In other words, when the baby begins to cry, a voice recognition microphone may be activated and patterns may be recognized. When the baby's cry has a slow frequency and a low waveform, whether the baby is hungry or requires replacement of the diaper may be determined using the smell recognition sensor.

When the baby is determined to be hungry, the controller may be configured to provide a notification to the user regarding close restaurants or other similar type of locations. In addition, when the baby begins to cry, the voice recognition microphone may be activated and the patterns may be recognized. In particular, when the baby's cry has a slow frequency and a low waveform (e.g., about 400.54±8.54 Hz), whether the baby is hungry or requires replacement of the diaper may be determined using the smell recognition sensor. When the baby is determined to require replacement of the diaper, the controller may be configured to provide a notification to the user regarding a nearby facility (e.g., facility having restrooms).

In addition, when the baby's cry has a fast frequency and a high intensity that may cause the baby to feel pain (e.g., about 441.04±11.66), whether the baby has a fever may be determined using the temperature sensor. When the baby is determined to have a fever, the controller may be configured to provide a notification to the user regarding a close pediatric hospital or other facility capable of providing resolution to the fever. In addition, when the baby's cry has a high intensity, whether the baby is sleepy or tired may be determined. When the baby is determined to be sleepy, the baby carriage may be moved by the controller in back and forth motions or in a circle pattern based on various existing input driving patterns and the controller may be configured to determine a driving pattern in which the baby's cry is reduced to learn and store the same. Thus, when the baby begins to cry, the baby carriage may be moved in the same pattern.

Furthermore, various services or remedies distinguished based on baby's cries may be provided for parents via a connection between the mobile communication terminal 110 (see FIG. 1) and a server. The baby carriage 120 may be configured to track the position of the mobile communication terminal 110 to follow the terminal while being maintained by a particular distance. In other words, when the controller 220 (see FIG. 2) determines the baby's condition information or the surrounding environment information and generates driving pattern information, the drive module 240 (see FIG. 2) may be driven based on the driving pattern information. In addition, it may be possible to provide the mobile communication terminal 110 with alarm signals and baby's condition information (steps S461 and S470). When the information provided in steps S451 to S456 is rejected, this information may be learned and stored in the database as a rejected history pattern (step S462).

In accordance with the exemplary embodiments of the present invention, the driving of a baby carriage may be appropriately controlled in various information patterns transferred based on baby's conditions such as cry. In addition, it may be possible to create a database for baby's conditions and provide various services that distinguish the baby's conditions such as pain a diaper replacement need. The baby carriage may also be configured to track the position of a parent's mobile communication terminal to follow the terminal, or may be configured to transmit alarm signals indicative of the baby's conditions.

While the present invention has been described with respect to the exemplary embodiments, it will be apparent to those skilled in the art that various changes and modifications may be made without departing from the spirit and scope of the invention as defined in the following claims.

What is claimed is:

1. An autonomous baby carriage, comprising:
a sensor module configured to detect a baby's condition to generate baby's condition information or detect a surrounding environment to generate surrounding environment information;
a controller configured to determine the baby's condition information or the surrounding environment information to generate driving pattern information; and
a drive module configured to be driven by the controller according to the driving pattern information.

2. The autonomous baby carriage of claim 1, wherein the baby's condition information is at least one selected from the group consisting of: a cry, a temperature, and a smell.

3. The autonomous baby carriage of claim 2, wherein the sensor module includes at least one selected from the group consisting of: a voice recognition sensor configured to recognize the cry, a temperature sensor configured to measure the temperature, and a smell recognition sensor configured to detect defecation.

4. The autonomous baby carriage of claim 1, further comprising:
an interlocking control module interlocked with a mobile communication terminal to transmit alarm information or the baby's condition information generated by the controller to the mobile communication terminal.

5. The autonomous baby carriage of claim 4, wherein the mobile communication terminal is configured to communicate with the interlocking control module using Bluetooth.

6. The autonomous baby carriage of claim 1, wherein the sensor module includes an Internet of Things (IOT) configured to detect the surrounding environment information.

7. The autonomous baby carriage of claim 1, wherein the driving pattern information is selected from a database in which previous baby's condition information is repeatedly learned and stored.

8. The autonomous baby carriage of claim 2, wherein the baby's condition information is distinguished using a basic frequency and an intensity of the cry.

9. A method of controlling an autonomous baby carriage, comprising:
detecting, by a sensor, a baby's condition to generate baby's condition information or detecting a surrounding environment to generate surrounding environment information;
determining, by a controller, the baby's condition information or the surrounding environment information to generate driving pattern information; and
driving, by the controller, a drive module based on the driving pattern information.

10. The method of claim 9, wherein the baby's condition information is at least one selected from the group consisting of: a cry, a temperature, and a smell.

11. The method of claim 10, wherein the sensor module includes at least one selected from the group consisting of: a voice recognition sensor configured to recognize the cry, a temperature sensor configured to measure the temperature, and a smell recognition sensor configured to detect defecation.

12. The method of claim 9, further comprising:
transmitting, by an interlocking control module, alarm information or the baby's condition information generated by the controller to a mobile communication terminal, wherein the interlocking control module is interlocked with the mobile communication terminal.

13. The method of claim 12, wherein the mobile communication terminal is configured to communicate with the interlocking control module using Bluetooth.

14. The method of claim 9, wherein the sensor module includes an Internet of Things (IOT) configured to detect the surrounding environment information.

15. The method of claim 9, wherein the driving pattern information is selected from a database in which previous baby's condition information is repeatedly learned and stored.

16. The method of claim 10, wherein the baby's condition information is distinguished using a basic frequency and an intensity of the baby's cry.
